(19) United States
(12) Patent Application Publication
(10) Pub. No.: US 2023/0196104 A1
(43) Pub. Date: Jun. 22, 2023

(54) AGENT ENABLED ARCHITECTURE FOR PREDICTION USING BI-DIRECTIONAL LONG SHORT-TERM MEMORY FOR RESOURCE ALLOCATION

(71) Applicant: University of Central Florida Research Foundation, Inc., Orlando, FL (US)

(72) Inventors: Shrirang Ambaji Kulkarni, Orlando, FL (US); Varadraj Gurupur, Oveido, FL (US); Christian King, Orlando, FL (US)

(73) Assignee: University of Central Florida Research Foundation, Inc., Orlando, FL (US)

(21) Appl. No.: 18/069,228

(22) Filed: Dec. 20, 2022

Related U.S. Application Data
(60) Provisional application No. 63/265,836, filed on Dec. 22, 2021.

(51) Int. Cl. G06N 3/08; G06N 3/0442; G06N 3/045; G06F 9/50

(52) U.S. Cl. CPC G06N 3/08; G06F 9/5027; G06N 3/045; G06N 3/0442

(57) ABSTRACT

In some implementations, a device may generate, using a machine learning model, a first output relating to an event during a first period of time. The machine learning model may be trained using training data. The device may obtain actual data relating to the event during a second period of time that precedes the first period of time. The device may generate updated training data based on the training data and the actual data. The device may train, using the updated training data, the machine learning model to generate an updated machine learning model. The device may generate, using the updated machine learning model, a second output relating to the event during a third period of time. The device may cause one or more resources to be allocated based on the second output.

### RELATED APPLICATION

This application claims priority to U.S. Provisional Pat. Application No. 63/265,836, entitled “AGENT ENABLED ARCHITECTURE FOR PREDICTION USING BI-DIRECTIONAL LONG SHORT-TERM MEMORY FOR RESOURCE ALLOCATION,” filed Dec. 22, 2021, which is incorporated herein by reference in its entirety.

### BACKGROUND

Artificial intelligence (AI) may be used to refer to intelligence demonstrated by a machine, in contrast to natural intelligence demonstrated by humans. The field of AI may include machine learning. A machine learning model utilizes training data and algorithms to make a prediction or to make a classification.

### SUMMARY

In some implementations, a method by a device includes generating, using a machine learning model, a first output relating to an event during a first period of time, wherein the machine learning model is trained using training data; obtaining actual data relating to the event during a second period of time that precedes the first period of time; generating updated training data based on the training data and the actual data; training, using the updated training data, the machine learning model to generate an updated machine learning model; generating, using the updated machine learning model, a second output relating to the event during a third period of time; and causing one or more resources to be allocated based on the second output.

In some implementations, a device includes one or more memories; and one or more processors, communicatively coupled to the one or more memories, configured to: generate, using a bi-directional long-short term memory (Bi-LSTM) model, a first output relating to an event during a first period of time, wherein the Bi-LSTM model is trained using training data; obtain actual data relating to the event during a second period of time that precedes the first period of time; generate updated training data based on the training data and the actual data; train, using the updated training data, the Bi-LSTM model to generate an updated Bi-LSTM model; generate, using the updated Bi-LSTM model, a second output relating to the event during a third period of time; and provide the second output to cause one or more resources to be allocated.

In some implementations, a non-transitory computer-readable medium storing a set of instructions includes one or more instructions that, when executed by one or more processors of a device, cause the device to: generate, using a bi-directional long short term memory (Bi-LSTM) model, a first output relating to an event during a first period of time, wherein the Bi-LSTM model is trained using training data; obtain actual data relating to the event during a second period of time that precedes the first period of time; generate updated training data based on the training data and the actual data; train, using the updated training data, the Bi-LSTM model to generate an updated Bi-LSTM model; generate, using the updated Bi-LSTM model, a second output relating to the event during a third period of time; and cause one or more resources to be allocated based on the second output.

### BRIEF DESCRIPTION OF THE DRAWINGS

FIGS. 1A-1E are diagrams of an example associated with using a Bi-LSTM model and an agent learner for determining resource allocation.

FIG. 2 is a diagram illustrating an example of training and using a machine learning model in connection with using a bi-directional long short-term memory for determining resource allocation.

FIG. 3 is a diagram of an example environment in which systems and/or methods described herein may be implemented.

FIG. 4 is a diagram of example components of one or more devices of FIG. 3.

FIG. 5 is a flowchart of an example process relating to using a Bi-LSTM model and an agent learner for determining resource allocation.

### DETAILED DESCRIPTION

The following detailed description of example implementations refers to the accompanying drawings. The same reference numbers in different drawings may identify the same or similar elements.

A machine learning model may be used to make predictions and make classifications. Existing machine learning models may be trained, using training data, to make the predictions and to make the classifications. In this regard, the predictions and the classifications are based on the training data which is existing data. The existing data may be associated with a particular subject matter. The machine learning model may include deep learning algorithms, such as recurrent neural networks (RNN) and/or convolutional neural networks (CNN).

Because existing machine learning models rely on the existing data in this manner, the ability of the machine learning models to make predictions is limited by the existing data. In other words, the existing machine learning models are unable to make accurate predictions regarding a subject matter that is unrelated to the particular subject matter associated with the existing data. Moreover, the existing machine learning models are unable to make accurate predictions for future trends regarding a subject matter (e.g., unable to make predictions regarding a subject matter relating to a distant future).

The inaccurate predictions may waste computing resources, storage resources, storage resources, among other resources that are used to take remedial actions regarding the inaccurate predictions. The remedial actions may include obtaining additional training data, retraining the machine learning models using the additional training data, among other remedial actions.

Implementations described herein are directed to generating accurate time series forecasting (e.g., forecasted time series data) using a combination of a deep learning model and an agent learning corroborator (or agent learning model). In some examples, the deep learning model may include a bi-directional long-short term memory (Bi-LSTM) model. In some implementations, the Bi-LSTM model may be more suitable for sequential data. Additionally, the Bi-LSTM model may be more suitable for sequential data of a minimal size (e.g., sequential data with five inputs, with three inputs, among other examples). The agent learning model may be a learning enabled artificial agent (e.g., an agent-based learning enabled model). In some implementations, a prediction system (e.g., including one or more devices) may use the combination of the Bi-LSTM model and the agent learning model to generate accurate time series forecasting regarding an event and to cause resources to be allocated based on the time series forecasting. In some examples, generating the time series forecasting regarding the event may include predicting a quantity of positive COVID-19 cases. In this regard, causing the resources to be allocated may include causing computing resources, network resources, storage resources, among other resources to be allocated to address the quantity of positive COVID-19.

The Bi-LSTM model may be trained using training data relating to the event. In some examples, the training data may be converted to a one time step input sequence (or single time step input sequence) and the Bi-LSTM model may be trained using the one time step input sequence. In some implementations, the Bi-LSTM model may be optimized. For instance, the Bi-LSTM model may be optimized based on a one timestep input sequence, a one timestep output sequence, a particular quantity of neurons, and/or a particular quantity of epochs. As an example, the Bi-LSTM model may be optimized based on a one timestep input sequence and a combination of fifteen neurons and one hundred epochs.

After being trained and/or optimized, the Bi-LSTM model may generate first time series forecasting (e.g., a time step output sequence). The first time series forecasting may be extrapolated data, relating to an event, for a particular day in a future. As an example, the first time series forecasting may include a prediction of a quantity of positive COVID-19 cases during the particular day. The agent learning model may obtain actual data that may be used to further train the Bi-LSTM in conjunction with the training data. For example, the agent learning model may obtain actual data, relating the event, regarding a day that precedes the particular day. As an example, the agent learning model may obtain information identifying an actual quantity of positive COVID-19 cases during the day that precedes the particular day.

The agent learning model may determine a forecasting error value based on the first time series forecasting and the actual data. Additionally, the agent learning model may determine a corrected value of the first time series forecasting based on the forecasting error value. The agent learning model may provide the corrected value as data that may be used to further train the Bi-LSTM model. By providing the forecasting error value in this manner, the agent learning mode may improve a measure of accuracy of time series forecasting of the Bi-LSTM model.

In some implementations, the agent learning model may determine whether a difference between the first time series forecasting and the actual data satisfy a threshold prior to determining the forecasting error value (and, consequently, the corrected value of the first time series forecasting). For example, if the difference satisfies the threshold, the agent learning model may determine the forecasting error value.

Alternatively, if the difference does not satisfy the threshold, the agent learning model may not determine the forecasting error value. By determining whether to determining the forecasting error value based on the threshold, implementations described herein may preserve computing resources, storage resources, storage resources, among other resources that would have otherwise been used to determine the forecasting error value every time the Bi-LSTM generates time series forecasting. In some implementations, the agent learning model may determine the forecasting error value independently of determining if the difference satisfies the threshold.

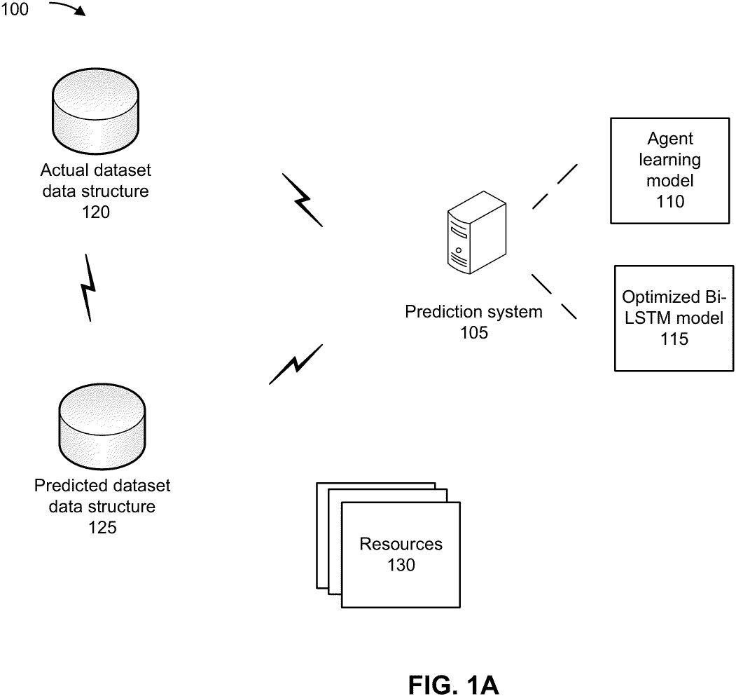

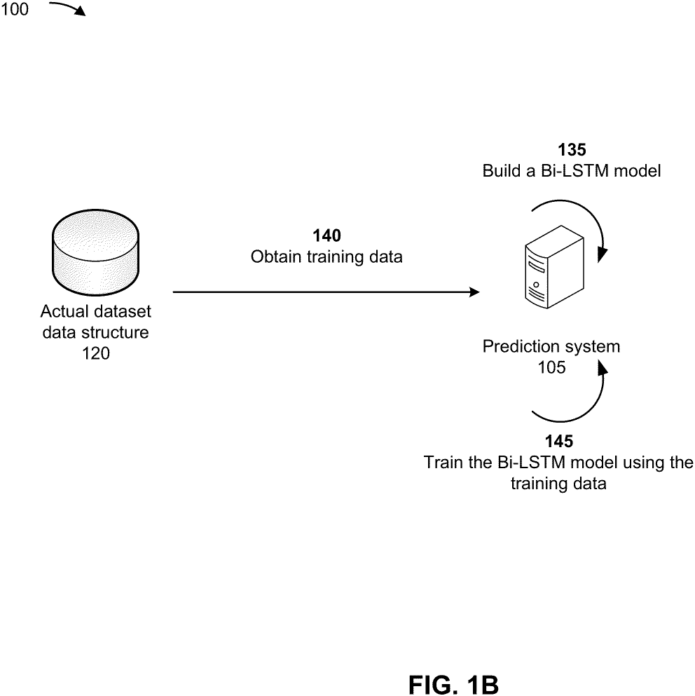

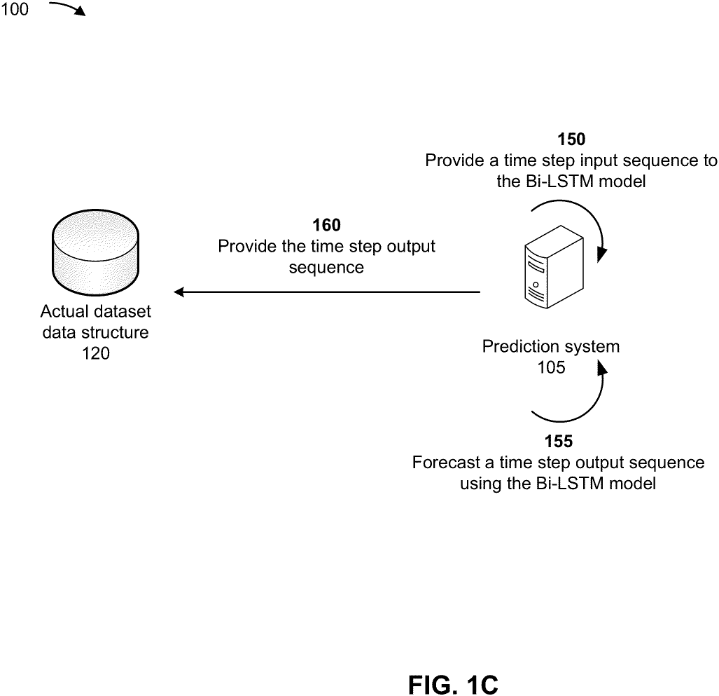

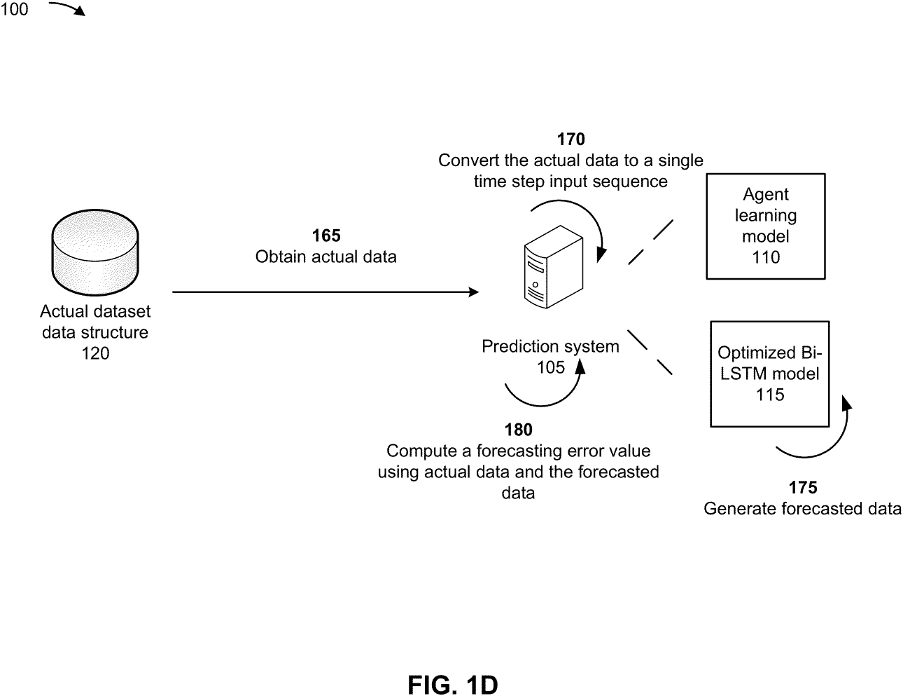

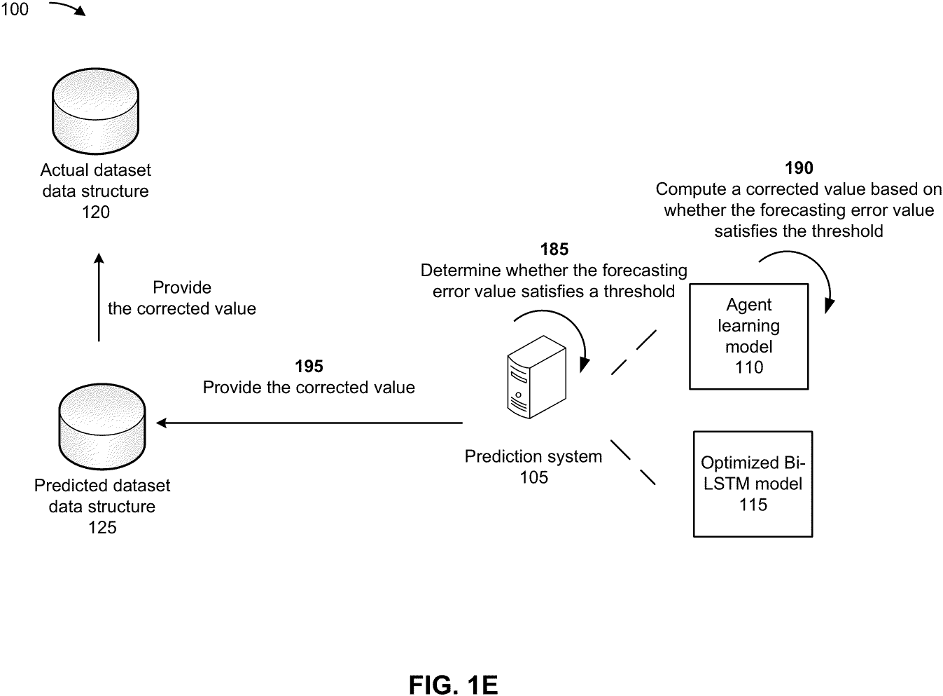

FIGS. 1A-1E are diagrams of an example 100 associated with using a Bi-LSTM model and an agent learner for determining resource allocation. As shown in FIGS. 1A-1E, example 100 includes a prediction system 105, an actual dataset data structure 120, a predicted dataset data structure 125, and one or more resources 130.

Prediction system 105 may include one or more devices capable of receiving, generating, storing, processing, and/or providing information associated with using a Bi-LSTM model and an agent learner for determining resource allocation, as described elsewhere herein. As shown in FIG. 1A, prediction system 105 may include an agent learning model 110 and an optimized Bi-LSTM model 115. Agent learning model 110 may include one or more devices configured to determine a corrected value of time series forecasting determined by optimized Bi-LSTM model 115, as described herein. The one or more devices may include a machine learning model. Optimized Bi-LSTM model 115 may be configured to determine time series forecasting. For example, optimized Bi-LSTM model 115 may be configured to forecast time series data of an event for a particular day based on actual time series data of the event for a day that precedes the particular day. In some examples, optimized Bi-LSTM model 115 may be a deep learning model.

Actual dataset data structure 120 may include a database, a table, a queue, and/or a linked list that stores data that may be used by optimized Bi-LSTM model 115 to forecast time series data. In some implementations, actual dataset data structure 120 may store actual data regarding one or more events. For example, actual dataset data structure 120 may store time series data of the one or more events. For instance, actual dataset data structure 120 may store time series data of a pandemic (e.g., COVID-19 cases), of global and/or local temperatures, of stock prices, of performance of a machine, among other examples. In some situations, the actual data may be used as training data to train and optimize optimized Bi-LSTM model 115.

Predicted dataset data structure 125 may include a database, a table, a queue, and/or a linked list that stores predicted data that is forecasted (or predicted) by optimized Bi-LSTM model 115 and/or determined by agent learning model 110. In some implementations, the predicted data may be provided from predicted dataset data structure 125 to actual dataset data structure 120. For example, the predicted data may be used to update the training data stored by actual dataset data structure 120. In other words, the predicted data may be used to further train optimized Bi-LSTM model 115 to improve a measure of accuracies of data predicted by optimized Bi-LSTM model 115.

Resources 130 may include one or more devices capable of receiving, generating, storing, processing, and/or providing information associated with using a Bi-LSTM model and an agent learner for determining resource allocation, as described elsewhere herein. Resources 130 may include computing resources (e.g., computing devices), storage resources (e.g., storage devi, and/or network resources (e.g., to provide network connectivity).

As shown in FIG. 1B, and by reference number 135, prediction system 105 may build a Bi-LSTM model. For example, prediction system 105 may build the Bi-LSTM model as part of a process to obtain an optimized Bi-LSTM model, such as optimized Bi-LSTM model 115. In some implementations, prediction system 105 may build the Bi-LSTM model with a number of LSTM neurons, with a rectified linear unit activation function, and with information identifying a time step input sequence and a time step output sequence. As an example, prediction system 105 may initially build the Bi-LSTM model with 15 neurons, with a one time step input sequence (or single time step input sequence), with a one time step output sequence (or single time step output sequence), and with 50 epochs. In some examples, prediction system 105 may add a single output layer of 1 node as part of building the Bi-LSTM model.

As shown in FIG. 1B, and by reference number 140, prediction system 105 may obtain training data. For example, after building the Bi-LSTM model, prediction system 105 may obtain the training data that is to be used to train the Bi-LSTM model. In some implementations, prediction system 105 may obtain the training data from actual dataset data structure 120. Alternatively, prediction system 105 may obtain the training data from another source.

As shown in FIG. 1B, and by reference number 145, prediction system 105 may train the Bi-LSTM model using the training data. In some examples, the Bi-LSTM model may be trained using an entirety of the training data. The training data may be actual data regarding an event. In this regard, prediction system 105 may use the training data to train the Bi-LSTM model to generate time series forecasting regarding the event. For instance, prediction system 105 may use the training data to train the Bi-LSTM model to forecast time series data regarding the event.

As shown in FIG. 1C, and by reference number 150, prediction system 105 may provide a time step input sequence to the Bi-LSTM model. In some implementations, after training the Bi-LSTM model, prediction system 105 may provide an input to the trained Bi-LSTM model to cause the trained Bi-LSTM model to forecast time series data. In some examples, the input may be a time step input sequence. In some situations, prediction system 105 may obtain data from actual dataset data structure 120. The data may be actual time series data regarding an event.

Prediction system 105 may convert the time series data to the time step input sequence (e.g., to a one time step input sequence). For example, the time step input sequence may be in the format of [number of records, number of time steps, and number of features]. The number of records may refer to the total number of records of the entirety of the training data. The number of time steps may refer to the number of sampled records as input sequence. Because the present example is a univariate time series problem, the number of features is 1. For example, if the training data includes 304 records, if the time step input sequence is a one (or single) time step input sequence, and if the feature is a single feature (e.g., next day forecasting), the time step input sequence may be [304, 1, 1].

As shown in FIG. 1C, and by reference number 155, prediction system 105 may forecast a time step output sequence using the Bi-LSTM model. For example, prediction system 105 may use the Bi-LSTM model to forecast an output related to the event. For instance, the input to the Bi-LSTM model may be time series data of a particular day (e.g., day n-1). In this regard, the Bi-LSTM model may forecast time series data for a day (e.g., day n) following the particular day.

As shown in FIG. 1C, and by reference number 160, prediction system 105 may provide the time step output sequence. In some implementations, prediction system 105 may provide the time step output sequence to actual dataset data structure 120. Alternatively, prediction system 105 may provide the time step output sequence to another source. Prediction system 105 may provide the time step output sequence to update the training data.

Prediction system 105 may repeat the actions described above in connection with FIGS. 1B and 1C for different numbers of LSTM neurons, different time step input sequences, different time step input sequences, and different numbers of epochs. Prediction system 105 may repeat the actions until the Bi-LSTM model is optimized (e.g., until optimized Bi-LSTM model 115 is derived). As an example, optimized Bi-LSTM model 115 may be derived using 15 neurons, a one time step input sequence, a one time step output sequence (or single time step output sequence), and 100 epochs.

As shown in FIG. 1D, and by reference number 165, prediction system 105 may obtain actual data. In some implementations, after building optimized Bi-LSTM model 115, prediction system 105 may obtain the actual data regarding an event. The actual data may be time series regarding the event. In some examples, prediction system 105 may obtain the actual data from actual dataset data structure 120.

In some implementations, the actual data may include the training data. Alternatively, the actual data may be different than the training data.

As shown in FIG. 1D, and by reference number 170, prediction system 105 may convert the actual data to a single time step input sequence. For example, because optimized Bi-LSTM model 115 is a Bi-LSTM that is build based on a single step input sequence, prediction system 105 may convert the actual data to the single time step input sequence. Prediction system 105 may convert the actual data to the single time step input sequence in a manner similar to the manner described above in connection with training a Bi-LSTM.

As shown in FIG. 1D, and by reference number 175, prediction system 105 may generate forecasted data. For example, prediction system 105 may generate an output based on the single time step input sequence. For instance, prediction system 105 may forecast time series data regarding the event (e.g., forecast a single time step output sequence regarding the event). As an example, if the single time step input sequence is based on time series data regarding the event for a period of time up to a particular day (e.g., day n-1), prediction system 105 may forecast time series data regarding the event for a next day (e.g., day n) following the particular day.

As shown in FIG. 1D, and by reference number 180, prediction system 105 may compute a forecasting error value using the actual data and the forecasted data. In some implementations, prediction system 105 may compute the forecasting error value using the following formula:

$${\text{C}}_{\text{E}} = 100 * \left(\left({\text{P}}_{\text{av}} - {\text{E}}_{\text{V}}\right) / {\text{P}}_{\text{av}}\right)$$

where C_{E} indicates the forecasting error value for a next day, where Pₐᵥ indicates the actual data (e.g., an actual value of the event for a previous day), and where Eᵥ indicates the forecasted data generated by optimized Bi-LSTM model 115.

In this regard, the forecasting error value may be modeled as a percentage of a regression error. The forecasting error value may be used to determine whether the forecasted value is to be corrected by agent learning model 110.

As shown in FIG. 1E, and by reference number 185, prediction system 105 may determine whether the forecasting error value satisfies a threshold. For example, after determining the forecasting error value, prediction system 105 may determine whether the forecasting error value satisfies the threshold. For example, prediction system 105 may compare the forecasting error value and the threshold to determine whether the forecasting error value is greater than or equal to the threshold.

Prediction system 105 may compare the forecasting error value and the threshold in order to determine whether the forecasted data is to be corrected by agent learning model 110. If prediction system 105 determines that the forecasting error value does not satisfy the threshold, prediction system 105 may provide the forecasted data to predicted dataset data structure 125. In some situations, predicted dataset data structure 125 may provide the corrected value to actual dataset data structure 120 to cause the training data to be updated with the forecasted value. Additionally, prediction system 105 may cause one or more resources 130 to be allocated based on the forecasted value. For example, the one or more resources 130 may include computing resources, storage resources, and/or network resources, among other examples.

As shown in FIG. 1E, and by reference number 190, prediction system 105 may compute a corrected value based on whether the forecasting error value satisfies the threshold. For example, agent learning model 110 may compute the corrected value for the forecasted value if prediction system 105 determines that the forecasting error value satisfies the threshold (e.g., the forecasting error value is greater than or equal to the threshold).

In some implementations, agent learning model 110 may compute the corrected value using the following formula:

$${\text{C}}_{\text{V}} = {\text{P}}_{\text{av}} + {\text{L}}_{\text{c}} ∗ \left({\text{C}}_{\text{E}} + \text{β} ∗ \left({\text{P}}_{\text{av}} - {\text{E}}_{\text{v}}\right)\right)$$

where Cᵥ indicates the corrected value, where Pₐᵥ indicates the actual data (e.g., an actual value of the event for a previous day), where L_{c} indicates the learning capability of the agent learning model tuned to consider the recent information (e.g., regarding the previous day), where C_{E} indicates the forecasting error value, where β indicates a factor to determine the current learning status, and where Eᵥ indicates the forecasted data generated by optimized Bi-LSTM model 115.

As an example, Lc may be set to 1.0 to prioritize the recent information (e.g., information regarding day n-1) and β may be set to 0.001 to consider the current learning status. Based on the foregoing, the process for agent learning model 110 may acquire the information of day n-1 and the information may used to correct the forecasted value for day n generated by optimized Bi-LSTM model 115.

Agent learning model 110 may learn to derive a corrective action by applying a transformative learning as modeled in the above formula. In some situations, agent learning model 110 may compute the corrected value irrespective of whether the forecasting error value satisfies the threshold. For example, agent learning model 110 may compute the corrected value each time optimized Bi-LSTM model 115 forecasts time series data regarding the event. In this regard, computing the corrected value based on whether the forecasting error value satisfies the threshold preserves computing resources, storage resources, and/or network resources that would have been used to compute the corrected value each time optimized Bi-LSTM model 115 forecasts time series data regarding the event.

In some implementations, prediction system 105 may determine the corrected value based on whether the actual data for the previous day (day n-1) is less than or equal to the forecasted value for the next day (day n). For example, if the actual data for the previous day (day n-1) is less than or equal to the forecasted value for the next day (day n), prediction system 105 may determine the corrected value using the formula:

$${\text{C}}_{\text{V}} = {\text{P}}_{\text{av}} + {\text{L}}_{\text{c}} ∗ \left({\text{C}}_{\text{E}} + \text{β} ∗ \left({\text{E}}_{\text{v}} - {\text{P}}_{\text{av}}\right)\right) .$$

For example, if the actual data for the previous day (day n-1) is less than or equal to the forecasted value for the next day (day n), prediction system 105 may determine the corrected value using the formula:

$${\text{C}}_{\text{V}} = {\text{P}}_{\text{av}} + {\text{L}}_{\text{c}} ∗ \left({\text{C}}_{\text{E}} + \text{β} ∗ \left({\text{P}}_{\text{av}} - {\text{E}}_{\text{v}}\right)\right) .$$

As shown in FIG. 1E, and by reference number 195, prediction system 105 may provide the corrected value. For example, after determining the corrected value, prediction system 105 may provide the corrected value to predicted dataset data structure 125. In some situations, predicted dataset data structure 125 may provide the corrected value to actual dataset data structure 120 to cause the training data to be update with the corrected value.

Additionally, prediction system 105 may cause one or more resources 130 to be allocated based on the corrected value. For example, the one or more resources 130 may include computing resources, storage resources, and/or network resources, among other examples,

Thus, the process of applying an agent learning algorithm (of agent learning model 110) will result in getting accurate forecasts data points inserted into predicted dataset data structure 125 and/or actual dataset data structure 120 in an incremental manner based on the number of forecasts visualized. Thus, every time optimized Bi-LSTM model 115 is trained, optimized Bi-LSTM model 115 is trained with more accurate values.

While the foregoing has been described with respect to time series forecasting relating to COVID-19 case, implementations described herein may be applicable to other time series data, such as global temperature, stock prices, among other examples. By using a combination of the deep learning model and the agent-based learning model as described herein, more accurate time series forecasting may be generated. By generating time series forecasting in this manner, the system described herein may preserve computing resources, storage resources, storage resources, among other resources that would have otherwise been used to take remedial actions regarding inaccurate predictions (e.g., inaccurate time series forecasting).

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

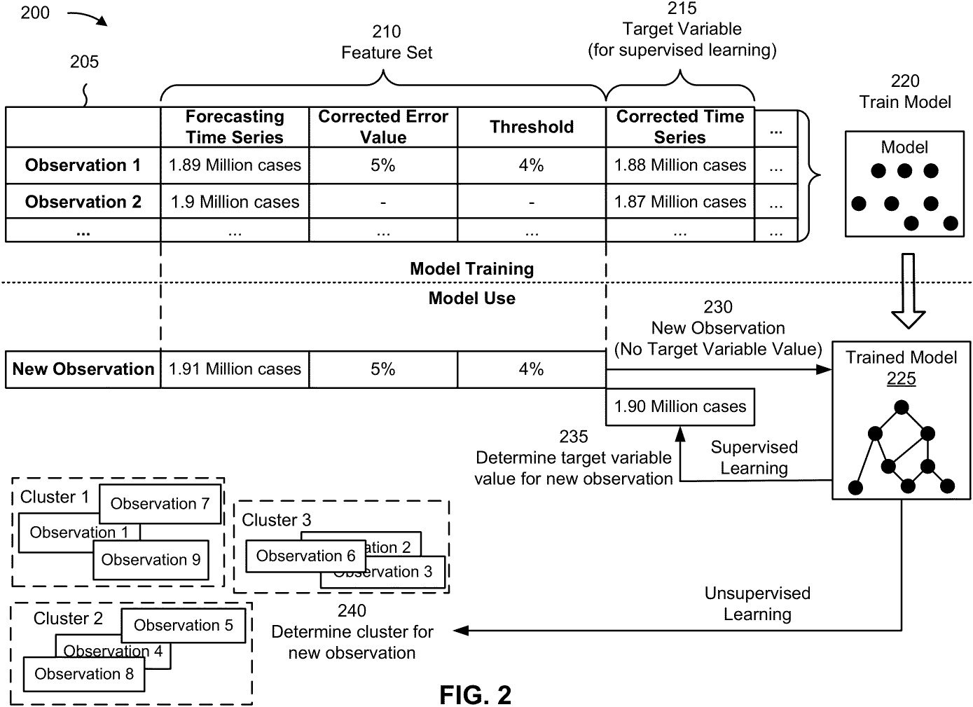

FIG. 2 is a diagram illustrating an example 200 of training and using a machine learning model in connection with using a bi-directional long short-term memory for determining resource allocation. The machine learning model training and usage described herein may be performed using a machine learning system. The machine learning system may include or may be included in a computing device, a server, a cloud computing environment, or the like, such as the computing described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the computing system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the computing system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of Forecasting Time Series, a second feature of Corrected Error Value, a third feature of Threshold, and so on. As shown, for a first observation, the first feature may have a value of 1.89 Million cases, the second feature may have a value of 5%, the third feature may have a value of 4%, and so on. These features and feature values are provided as examples, and may differ in other examples. For example, the feature set may include one or more of the following features: forecasting error value, training data, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 100, the target variable is Corrected Time Series, which has a value of 1.88 Million cases for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of 1.91 Million cases, a second feature of 5%, a third feature of 4%, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 1.90 Million cases for the target variable of Corrected Time Series for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, allocate resources for anticipated 1.90 Million cases. The first automated action may include, for example, allocating computing resources, network resources, and storage resources.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to using a bi-directional long short-term memory for determining resource allocation. The machine learning system enables recognition and/or identification of tens, hundreds, thousands, or millions of features and/or feature values for tens, hundreds, thousands, or millions of observations, thereby increasing accuracy and consistency and reducing delay associated with using a bi-directional long short-term memory for determining resource allocation relative to requiring computing resources to be allocated for tens, hundreds, or thousands of operators to manually using a bi-directional long short-term memory for determining resource allocation using the features or feature values.

As indicated above, FIG. 2 is provided as an example. Other examples may differ from what is described in connection with FIG. 2.

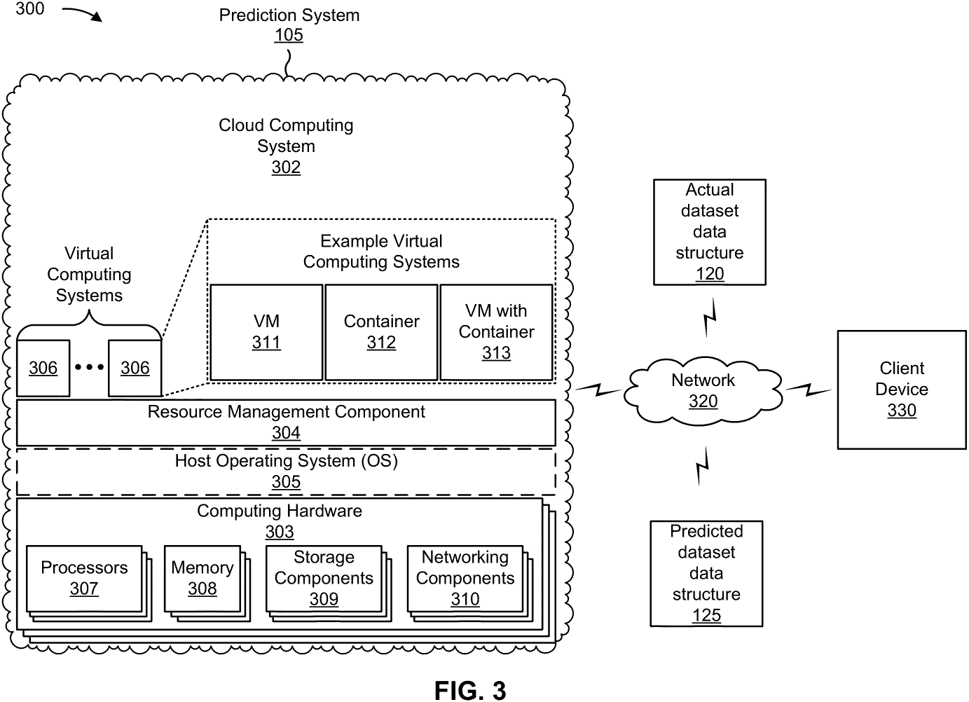

FIG. 3 is a diagram of an example environment 300 in which systems and/or methods described herein may be implemented. As shown in FIG. 3, environment 300 may include a prediction system 105, which may include one or more elements of and/or may execute within a cloud computing system 302. The cloud computing system 302 may include one or more elements 303-313, as described in more detail below. As further shown in FIG. 3, environment 300 may include a network 320 and/or a client device 330. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, or a hybrid environment 313 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

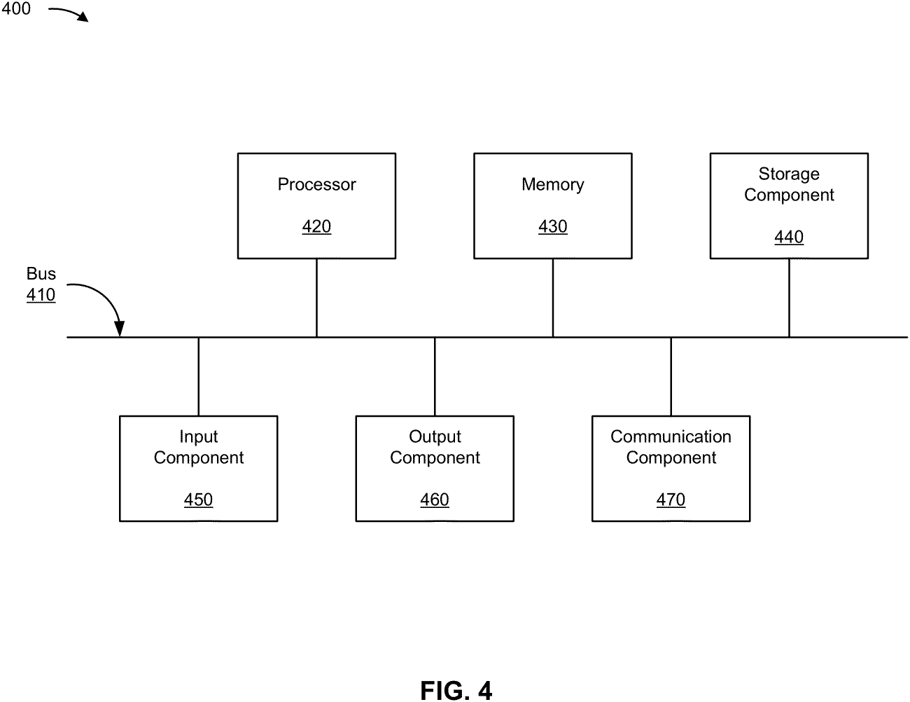

Although the prediction system 105 may include one or more elements 303-313 of the cloud computing system 302, may execute within the cloud computing system 302, and/or may be hosted within the cloud computing system 302, in some implementations, the prediction system 105 may not be cloud-based (e.g., may be implemented outside of a cloud computing system) or may be partially cloud-based. For example, the prediction system 105 may include one or more devices that are not part of the cloud computing system 302, such as device 400 of FIG. 4, which may include a standalone server or another type of computing device. The prediction system 105 may perform one or more operations and/or processes described in more detail elsewhere herein.

Network 320 includes one or more wired and/or wireless networks. For example, network 320 may include a cellular network, a public land mobile network (PLMN), a local area network (LAN), a wide area network (WAN), a private network, the Internet, and/or a combination of these or other types of networks. The network 320 enables communication among the devices of environment 300.

The client device 330 includes one or more devices capable of receiving, generating, storing, processing, and/or providing information described herein. The client device 330 may include a communication device and/or a computing device. For example, the client device 330 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. The client device 330 may communicate with one or more other devices of environment 200, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to prediction system 105 and/or client device 330. In some implementations, prediction system 105 and/or client device 330 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

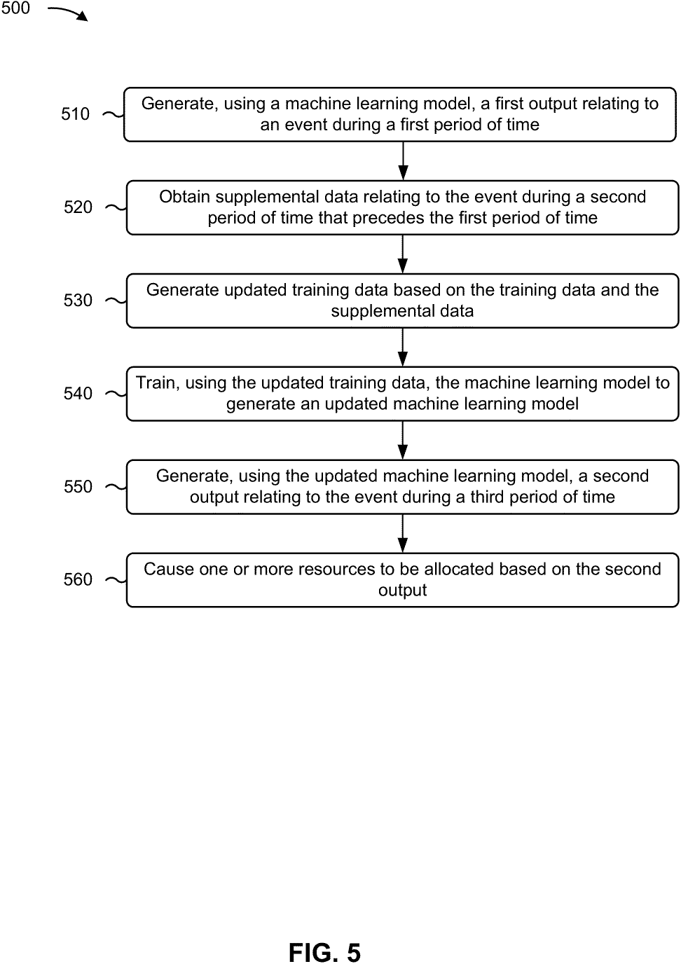

FIG. 5 is a flowchart of an example process 500 relating to using a bi-directional long short-term memory for determining resource allocation. In some implementations, one or more process blocks of FIG. 5 may be performed by a prediction system (e.g., prediction system 105). In some implementations, one or more process blocks of FIG. 5 may be performed by another device or a group of devices separate from or including the computing system, such as a client device (e.g., client device 330). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include generating, using a machine learning model, a first output relating to an event during a first period of time, wherein the machine learning mode is trained using training data (block 510). For example, the computing system may generate, using a machine learning model, a first output relating to an event during a first period of time, wherein the machine learning mode is trained using training data, as described above. In some implementations, the machine learning mode is trained using training data.

As further shown in FIG. 5, process 500 may include obtaining actual data relating to the event during a second period of time that precedes the first period of time (block 520). For example, the computing system may obtain actual data relating to the event during a second period of time that precedes the first period of time, as described above.

As further shown in FIG. 5, process 500 may include generating updated training data based on the training data and the actual data (block 530). For example, the computing system may generate updated training data based on the training data and the actual data, as described above.

As further shown in FIG. 5, process 500 may include training, using the updated training data, the machine learning model to generate an updated machine learning model (block 540). For example, the computing system may train, using the updated training data, the machine learning model to generate an updated machine learning model, as described above.

As further shown in FIG. 5, process 500 may include generating, using the updated machine learning model, a second output relating to the event during a third period of time (block 550). For example, the computing system may generate, using the updated machine learning model, a second output relating to the event during a third period of time, as described above.

As further shown in FIG. 5, process 500 may include causing one or more resources to be allocated based on the second output (block 560). For example, the computing system may cause one or more resources to be allocated based on the second output, as described above.

Process 500 may include additional implementations, such as any single implementation or any combination of implementations described below and/or in connection with one or more other processes described elsewhere herein.

In a first implementation, process 500 includes determining a difference between the first output and the actual data, determining whether the difference satisfies a threshold, and wherein training, using the updated training data, the machine learning model comprises training the machine learning model using the updated training data based on determining whether the difference satisfies the threshold.

In a second implementation, process 500 includes determining that the difference satisfies the threshold, and wherein training, using the updated training data, the machine learning model comprises training the machine learning model using the updated training data based on determining that the difference satisfies the threshold.

In a third implementation, training the machine learning model comprises training a deep learning model using the updated training data.

In a fourth implementation, training the machine learning model comprises training a bi-directional long-short term memory (Bi-LSTM) model using the updated training data.

In a fifth implementation, process 500 includes converting the training data to a one timestep input sequence, and training the machine learning model using the one timestep input sequence prior to generating the first output, wherein generating the first output comprises generating first time series forecasting regarding the event, and wherein generating the second output comprises generating second time series forecasting regarding the event.

In a sixth implementation, the machine learning model is a first machine learning model. Process 500 includes determining a forecasting error value based on a difference between the first output and the actual data, determining, using a second machine learning model, a corrected value for the first output based on the forecasting error value satisfying a threshold, and generating the updated training data based on the corrected value.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method by a device, the method comprising:
generating, using a machine learning model, a first output relating to an event during a first period of time,
wherein the machine learning model is trained using training data;
obtaining actual data relating to the event during a second period of time that precedes the first period of time;
generating updated training data based on the training data and the actual data;
training, using the updated training data, the machine learning model to generate an updated machine learning model;
generating, using the updated machine learning model, a second output relating to the event during a third period of time; and
causing one or more resources to be allocated based on the second output.

2. The method of claim 1, further comprising:
determining a difference between the first output and the actual data;
determining whether the difference satisfies a threshold; and
wherein training, using the updated training data, the machine learning model comprises:
training the machine learning model using the updated training data based on determining whether the difference satisfies the threshold.

3. The method of claim 2, further comprising:
determining that the difference satisfies the threshold; and
wherein training, using the updated training data, the machine learning model comprises:
training the machine learning model using the updated training data based on determining that the difference satisfies the threshold.

4. The method of claim 1, wherein training the machine learning model comprises:
training a deep learning model using the updated training data.

5. The method of claim 1, wherein training the machine learning model comprises:
training a bi-directional long-short term memory (Bi-LSTM) model using the updated training data.

6. The method of claim 1, further comprising:
converting the training data to a one timestep input sequence; and
training the machine learning model using the one timestep input sequence prior to generating the first output;
wherein generating the first output comprises:
generating first time series forecasting regarding the event; and
wherein generating the second output comprises:
generating second time series forecasting regarding the event.

7. The method of claim 1, wherein the machine learning model is a first machine learning model, and
wherein generating the updated training data comprises:
determining a forecasting error value based on a difference between the first output and the actual data;
determining, using a second machine learning model, a corrected value for the first output based on the forecasting error value satisfying a threshold; and
generating the updated training data based on the corrected value.

8. A device, comprising:
one or more memories; and
one or more processors, communicatively coupled to the one or more memories, configured to:
generate, using a bi-directional long-short term memory (Bi-LSTM) model, a first output relating to an event during a first period of time,
wherein the Bi-LSTM model is trained using training data;
obtain actual data relating to the event during a second period of time that precedes the first period of time;
generate updated training data based on the training data and the actual data;
train, using the updated training data, the Bi-LSTM model to generate an updated Bi-LSTM model;
generate, using the updated Bi-LSTM model, a second output relating to the event during a third period of time; and
provide the second output to cause one or more resources to be allocated.

9. The device of claim 8, wherein the one or more processors are further configured to:
generate the Bi-LSTM model based on a one timestep input sequence;
convert the training data to a timestep input sequence; and
train the Bi-LSTM model using the timestep input sequence prior to generating the first output.

10. The device of claim 8, wherein the one or more processors, to generate the updated training data, are configured to:
determine a forecasting error value based on a difference between the first output and the actual data; and
generate the updated training data based on the forecasting error value.

11. The device of claim 10, wherein the one or more processors, to generate the updated training data, are configured to:
determine, using an agent learning model, a corrected value for the first output based on the forecasting error value satisfying a threshold; and
generate the updated training data based on the corrected value.

12. The device of claim 8, wherein the one or more processors, to generate the first output, are configured to:
forecast a first timestep output sequence regarding the event; and
wherein the one or more processors, to generate the second output, are configured to:
forecast a second timestep output sequence regarding the event.

13. The device of claim 8, wherein the one or more processors, to train the Bi-LSTM model, are configured to:
determine a difference between the first output and the actual data;
determine whether the difference satisfies a threshold; and
train the Bi-LSTM model using the updated training data based on determining whether the difference satisfies the threshold.

14. The device of claim 13, wherein the one or more processors, to train the BI-LSTM model, are configured to:
determine that the difference satisfies the threshold; and
train the Bi-LSTM model using the updated training data based on determining that the difference satisfies the threshold.

15. A non-transitory computer-readable medium storing a set of instructions, the set of instructions comprising:
one or more instructions that, when executed by one or more processors of a device, cause the device to:
generate, using a bi-directional long-short term memory (Bi-LSTM) model, a first output relating to an event during a first period of time,
wherein the Bi-LSTM model is trained using training data;
obtain actual data relating to the event during a second period of time that precedes the first period of time;
generate updated training data based on the training data and the actual data;
train, using the updated training data, the Bi-LSTM model to generate an updated Bi-LSTM model;
generate, using the updated Bi-LSTM model, a second output relating to the event during a third period of time; and
cause one or more resources to be allocated based on the second output.

16. The non-transitory computer-readable medium of claim 15, wherein the one or more instructions, that cause the device to generate the first output, cause the device to:
generate first time series forecasting regarding the event; and
wherein the one or more instructions, that cause the device to generate the second output, cause the device to:
generate second time series forecasting regarding the event.

17. The non-transitory computer-readable medium of claim 15, wherein the one or more instructions, that cause the device to generate the updated training data, cause the device to:
determine a forecasting error value based on a difference between the first output and the actual data; and
generate the updated training data based on the forecasting error value.

18. The non-transitory computer-readable medium of claim 17, wherein the one or more instructions, that cause the device to generate the updated training data, cause the device to:
determine a corrected value based on the forecasting error value; and
generate the updated training data based on the corrected value.

19. The non-transitory computer-readable medium of claim 15, wherein the one or more instructions, that cause the device to generate the updated training data, cause the device to:
determine a difference between the first output and the actual data;
determine whether the difference satisfies a threshold; and
determine, using an agent learning model, a corrected value for the first output based on based on determining whether the difference satisfies the threshold.

20. The non-transitory computer-readable medium of claim 19, wherein the one or more instructions, that cause the device to generate the updated training data, cause the device to:
determine that the difference satisfies the threshold;
include the corrected value in the updated training data; and
train the Bi-LSTM model using the updated training data based on determining that the difference satisfies the threshold.
